(19) United States
(12) Patent Application Publication
(10) Pub. No.: US 2012/0264099 A1
(43) Pub. Date: Oct. 18, 2012

(54) SYSTEM AND METHOD FOR NETWORK-BASED TUTORING

(76) Inventor: MACK CRAFT, IV, ST. AUGUSTINE, FL (US)

(21) Appl. No.: 13/445,372

(22) Filed: Apr. 12, 2012

Related U.S. Application Data
(60) Provisional application No. 61/516,997, filed on Apr. 12, 2011.

(51) Int. Cl. G09B 5/00

(52) U.S. Cl. 434/350

(57) ABSTRACT

A computer-based online interactive educational system and method are described herein, wherein the system comprises a first and second network-connected computers for providing access to the system for a student and a tutor, a database server for storing data pertaining to the student and tutor, a system software, a multi-video web-based interlace and a plurality of communication tools to facilitate instant discussion between the student and tutor over a specific learning subject.

### CROSS-REFERENCE TO RELATED APPLICATION

This application claims the benefit of U.S. Provisional Application Ser. No. 61/516,997 filed on Apr. 12, 2011, the contents of which are herein incorporated by reference in their entirety.

### FIELD OF THE INVENTION

The present invention relates to a network-based tutoring system, and more particularly, to computer-based systems and methods for facilitating the same.

### BACKGROUND OF THE INVENTION

It is becoming increasingly important for individuals and students to be skilled or highly knowledgeable in a specific subject matter or area of interest. However, such training is both time-consuming and expensive to provide. In particular, there are expenses associated with tutoring materials as well as travel expenses for either (or both) trainers and trainees. To alleviate some of these expenses, automated learning or tutorial systems have been developed. However, such systems provide minimal interaction between the participants or, if highly interactive, may require substantial hardware and/or software expenditures which limit their use to highly equipped “training centers.” Further, there may still remain substantial travel expenditures for participants of such training centers.

Accordingly, it would be advantageous to have a highly interactive tutorial system for teaching or tutoring users regarding a particular subject that both reduces the need for trainers/trainees to travel and is readily accessible by users via network-based computers. Embodiments of the present invention are directed to a network-based system and methods for tutoring that is accessible to students 24 hours a day via a low-cost, flat fee, interactive online educational system.

### SUMMARY OF THE INVENTION

In view of the foregoing, it is an object of the present invention to provide an improved system and method for network-based tutoring. Embodiments of the present invention are directed to an online interactive educational system, the system comprising: a network; first and second computers connected to and providing access to the network for a student and a tutor, respectively; a database server connected to the network for storing data pertaining to the student and the tutor; system software connected to the first and second computers and to the database server for coordinating interaction between the tutor and the student; each computer having a two-way video interface wherein each student can interact live with the tutor or another student; and a plurality of communication tools connected in the network to facilitate discussions between each student and the tutor. In one embodiment, the system further comprises an online homework network wherein the student uploads homework to the database server. As referred herein, the communication tools includes, but is not limited to, talk, text, whiteboard, video and chat.

The database server permits the tutor to review the student's homework assignment without online instant discussion between the tutor and the student. Furthermore, the video interfaces permit the tutor to review at least one student's homework assignment through an online instant discussion between the tutor and the student. In one embodiment, the system further comprises a shared platform wherein a plurality of tutor's share revenue and educational tasks of the student. A shared tutor's platform comprises, but is not limited to, homework help platform, homework review platform, computer-based tutoring platform, instructional learning platform, classroom platform and communication tools. The shared platform allows parents and students an affordable solution to homework help, tutoring, instructional learning or any digital learning.

In yet another embodiment, an online interactive educational method is described, wherein the method is being executed by at least two network-connected computers. The method as described herein comprises: providing a network; associating first and second computers with the network and with a student's and a tutor's database, respectively; storing at least one tutoring event for a specific subject by the tutor in a central database server; providing access with software to the tutoring event for at least one student and one tutor; providing a multi-video, web-based interface wherein the student interacts live with the tutor or another student through the software; and providing a plurality of communication tools to facilitate instant discussions between each student and the tutor, wherein the tutor and at least one student interact with each other.

In one embodiment, the method further comprises providing a homework network wherein the student uploads a homework assignment onto the database server and the tutor reviews the homework on the database server. The tutor reviews the student's homework assignment without online instant discussion between the tutor and the student. Alternatively, the tutor reviews at least one student's homework assignment through the online instant discussion between the tutor and the student. In yet another embodiment, the method further comprises the additional step of providing a calendar of all tutoring events associated with each tutor to every student.

In one embodiment, a method of calculating a tutor's overall compensation in an online interactive educational system is described. This method comprises (a) associating a first compensation value with every referred student to the system by the tutor; (b) associating a second compensation value with every student who has an educational interaction with the tutor, wherein the educational interaction comprises at least one of online interactive tutoring, online interactive homework help and offline interactive homework help; (c) multiplying the first compensation value by a number of the referred students to determine the first reimbursement value; and (d) multiplying the second compensation value by number of the students with the educational interaction to determine the second reimbursement value, wherein the tutor's overall compensation is calculated by adding the first and second reimbursement values. The first compensation value is less than the second compensation value. Furthermore, the referred student by the tutor can utilize the educational interaction of another non-referred tutor in the system. The non-referred tutor will not be compensated for the first compensation value of the student.

In yet another embodiment, the tutor is further compensated based on a number of banking points the tutor receives from each student, wherein the banking points includes popularity of the tutor with students, good reviews from students and duration of work in the system. The specific learning subject comprises career-related tutoring, academic tutoring and non-academic tutoring. The multi-video, web-based interface allows the student and the tutor to view each other on the system through use of video device connected to the student's and the tutor's computer.

### BRIEF DESCRIPTION OF THE DRAWINGS

FIG. 1 is a schematic overview of an online interactive educational system in accordance to embodiments of the present invention;

FIG. 2 is a schematic overview of a tutor's database in accordance to the system of FIG. 1;

FIG. 3 is a schematic overview of a student's database in accordance to the system of FIG. 1;

FIG. 4 is a schematic overview of an online interactive educational system relating to a student's database;

FIG. 5 is a schematic overview of an online interactive educational system relating to a tutor's database;

FIG. 6 illustrates an exemplary interactive, multi-video virtual classroom;

FIG. 7 illustrates an exemplary interactive, multi-video virtual Study Hall;

FIG. 8 illustrates an exemplary homework review network;

FIG. 9 illustrates how a student can schedule classes based on subject matter and tutor on a network calendar; and

FIG. 10 illustrates an exemplary homework help network.

### DETAILED DESCRIPTION OF PREFERRED EMBODIMENTS

Before the present systems and methods are described, it is to be understood that this invention is not limited to the particular system or methodologies described, as these may vary. It is also to be understood that the terminology used in the description is for the purpose of describing the particular versions or embodiments only, and is not intended to limit the scope of the present invention. Unless defined otherwise, all technical terms used herein have the same meanings as commonly understood by one of ordinary skill in the art. Although any methods and system similar or equivalent to those described herein can be used in the manufacture, practice or testing of embodiments of the present invention, the preferred systems and methods are now described.

It must also be noted that as used herein and in the appended claims, the singular forms “a”, “an”, and “the” include plural reference unless the context clearly dictates otherwise.

As used herein a teacher and a tutor are used interchangeably and refer to an individual who teaches at least one specific subject. Specific subjects are related to academic, non-academic, business and hobby topics.

As used herein “homework” refers to any digital document, video or book which requires revision, discussion, comprehension or editing.

As used herein “tutoring” refers to instructional learning, lessons, consulting, mentoring, homework help and homework review.

As used herein a “web-based interface” is a system that accepts input via devices such as computer keyboard and mouse and provides output by generating web pages which are transmitted via the internet and viewed by the user using a web browser program. As used herein a “multi-video web-based interface” is a web-based interface that allows users to view each other on the web browser through the use of a video device connected to, or part of each user's computer.

As used herein and as described in more detail in the embodiments of the present disclosure, a “communication tool” is any tool that allows for or facilitates communication of each user with other participants in the network-based educational system. Non-limiting examples of “communication tool” includes talk, text, and chat buttons.

As used herein and as described in more detail in the embodiments of the present disclosure, a “landing page” is a webpage wherein the tutor and the student arrive at after sign up and logging into with the online interactive educational system.

As used herein a “Students Hall” is a landing page for students when they access the online educational system after signing up.

As used herein a “Study Hall” is a web-based interactive component of the Students Hall where students can virtually meet to discuss a particular subject with or without presence of a tutor.

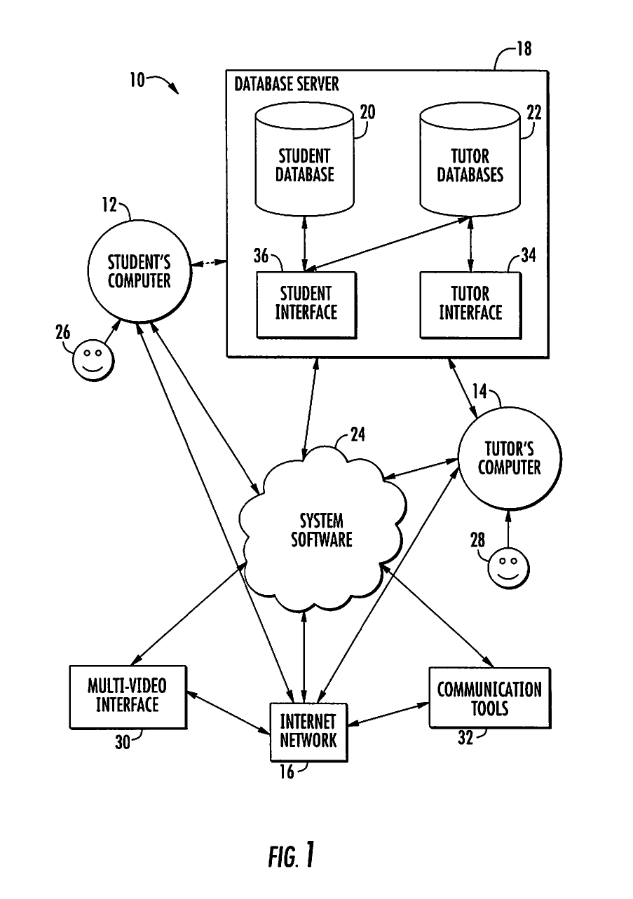

Referring to FIG. 1, according to an embodiment of the present invention, an online interactive educational system 10 includes a student's computer 12 and a tutor's computer 14. The computers 12 and 14 are connected to the internet network 16 for providing access to the system 10. The system 10 further includes a database server 18 for storing data pertaining to student database 20 and tutor database 22. The system 10 further includes a system software means 24 which is connected to the student's computer 12, the tutor's computer 14, the internet network 16 and the database server 18 for coordinating interaction between the student 26 and the tutor 28. In yet another embodiment, the system 10 further includes a multi-video, web-based interface 30 wherein the student 26 interacts live with another student 26 or the tutor 28 through the software 24. In yet another embodiment, the system 10 includes at least one communication tool 32 to facilitate instant discussion between the student 26 and tutor 28 through software 24. In one embodiment, the tutor 28 and at least one student 26 interact with each other over a specific learning project through the network-based system 10.

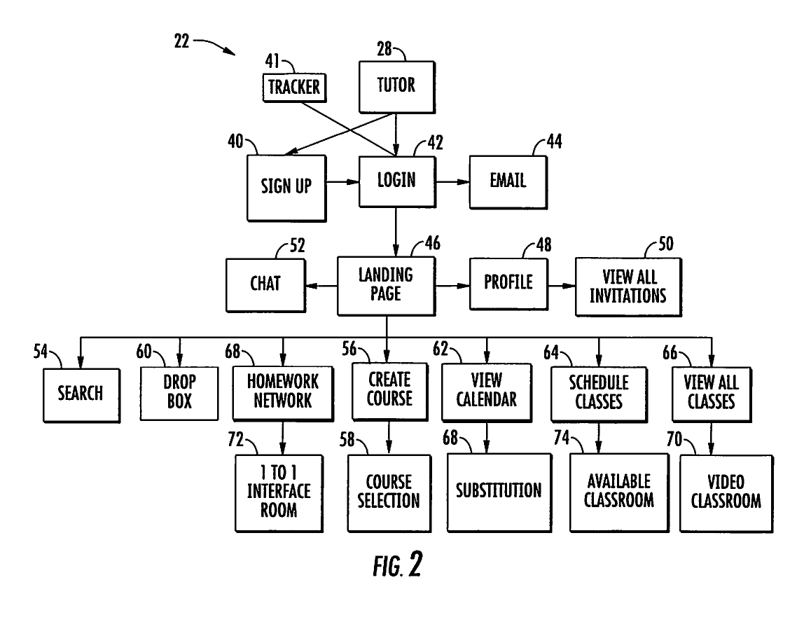

Referring back to FIG. 1, in one embodiment of the invention, tutor's 28 information is stored in the tutor's database 22 of database server 18 of the system 10. Such information is then readily available on the tutor interface 34 to the tutor 28 and the student 26 who is a member of the system 10. Referring to FIG. 2, in one embodiment of the invention the tutor 28 is provided access to the tutor database 22. In one embodiment, the tutor 28 enters a sign up page 40 on the tutor database 22 by providing basic biographical information. In yet another embodiment, the tutor 28 undergoes an approval process by the administrator of the system 10 (Tutoring Minds™) prior to signing up. In yet another embodiment, optionally a set of pre-selected data is sent to an affiliate third party software or tracker 41. As soon as the tracker 41 receives the data, it creates a tutor ID and unique key and sends it back to the system 10. Now this ID will be saved on the database server 18 (depicted in FIG. 1), so it can be used for communication with the tracker 41 in the future.

Once the tutor 28 signs up with the system 10, the tutor 28 is requested to login 42 using tutor's 28 email address 44. In one embodiment, once the tutor 28 accesses sign up page 40 with the system 10 and undergoes the authentication with the tracker 41, he can directly access the login 42 for future access to the database server 18. After login 42, the tutor 28 is then directed to a landing page 46 to be able to view and edit his profile 48. In yet another embodiment, the landing page 46 is visible to other tutors 28 and students 26 who are part of the system 10. In yet another embodiment, the tutor 28 is able to view calendar 62, schedule of classes 64 and view all classes 66 through the landing page 46. In yet another embodiment, tutor 28 may modify their calendar 62 with a substitute event 68. In yet another embodiment, tutor 28 may select a video classroom 70 after viewing all classes 66. In yet another embodiment, tutor 28 is able to access available classrooms 74 from schedule of classes 64.

The tutor 28 can access all invitations 50 pending from students 26 from his profile 48. In yet another embodiment, tutor 28 accesses a chat interlace 52 from the landing page 46 as a communication tool to interact with students 26. The tutor 28 can access a search command 54 to search for other tutors 28 to add as part of tutor's interface 34. In yet another embodiment, tutor 28 is not able to search the students 26 and access is restricted. The tutor 28 can create at least one available course 56 (as supported by Tutoring Minds™) directed to a particular subject matter. A tutor 28 creates courses 56 based on the course selection list 58. A tutor 28 can create as many courses 56 as he wants, but such creation is strictly based on the course selection list 58 for the tutor 28. In one embodiment, a tutor 28 is able to create, edit and view all of his courses 56.

Every tutor 28 has access to a drop box 60 where students 26 can drop their homework/assignment for the tutor 28 to review. Every time a new document is dropped in this box 60, an email alert will be sent to the tutor that includes subject of the home work student submitted. Each tutor 28 has access to a homework network 68. This network 68 focuses mainly on helping students with their homework. In yet another embodiment, a one on one interference room 72 is accessed from the homework network 68 where there is one on one interaction between the tutor 28 and students 26. There may also be cases where a tutor will help more than one student 26 with the same homework. The homework network 68 allows for live interaction between the tutor 28 and the student 26 over a homework assignment. In yet another embodiment, student 26 uploads their homework document as a word doc or a PDF file and the tutor will be able to download and open this file during the session. In yet another embodiment, communications tools such as, but not limited to, chat capability, texting, video interface and white board is available on the one to one interface room 72.

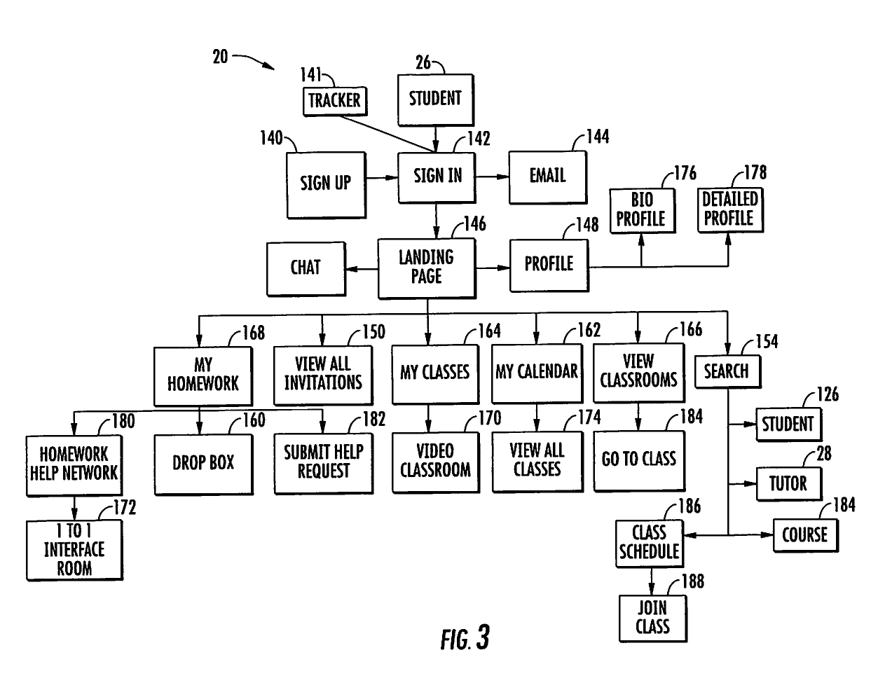

Referring back to FIG. 1, in one embodiment of the invention, student's 26 information is stored in the student's database 20 of database server 18 of the system 10. Such information is then readily available on the student interface 36 to the tutor 28 and the student 26. Referring to FIG. 3, the student 26 is provided access to the student database 20 through student computer 12. In one embodiment, the student 26 enters a sign up page 140 to the student database 20 by providing basic biographical information. In yet another embodiment, optionally a set of pre-selected data is sent to an affiliate third party software or tracker 141. As soon as the affiliate server receives the data, it creates a student ID and a unique key and sends it back to the database server 18. This ID will be saved on the database server 18 (depicted in FIG. 1), so it can be used for communication with the affiliate server in the future.

Referring back to FIG. 3, once the student 26 signs up with the system 10 (Tutoring Minds™), the student 26 will be requested to login 142 using student's 26 email address 144. Once the student 26 accesses sign up 140 of the system 10, he can directly access the login 142. After login 142, the student 26 is then directed to a landing page 146 to be able to view and edit his profile information 148. In yet another embodiment, the landing page 146 is visible to other tutors 28 and students 26 who are part of the Shared Teachers Network and Shared Students Network. In yet another embodiment, profile 148 comprises a bio profile 176 and a detailed profile 178.

Referring to FIGS. 1 and 3, the student 26 is able to view calendar 162, schedule of classes 164 and view all class rooms 166 at the landing page 146. In yet another embodiment, every student 26 has access to a homework network 168. This network focuses mainly on students 26 obtaining help with their homework assignments. In yet another embodiment, every student 26 has access to a drop box 160 where students 26 can drop their homework or assignments for the tutor 28 to review. Every time a new document is dropped in this box 160, a submit help request interface 182 is initiated where an alert is sent to the tutor 28 that includes subject of the home work student submitted.

A one on one interference room 172 is accessed from the homework help network 180 where there is a one on one interaction between the tutor 28 and students 26. There may also be cases where a tutor 28 helps more than one student 26 with the same homework. The homework help network 180 allows for live interaction between the tutor 28 and the student 26 over a homework assignment. Student 26 can select a video classroom 170 after viewing all of student's selected classes 164. In yet another embodiment, student 26 can alternatively select “go to class” 184 from view classroom interface 166. The student 26 is able view all classes 174 from the student's calendar 162. The student 26 accesses and views all invitations 150 pending from students 26. The student 26 accesses a search command 154 to search for tutors 28, search for other students 126 or search for courses 186. The search 154 is performed by student 26 based on class schedule 186. If student 26 finds any desirable results based on search 154, the student 26 can join such class 188.

Embodiments of the present invention are directed to a computer based interactive multi-video conference system and method that provide network-based classrooms via internet with a vision of providing practical solutions for students' and individual's educational challenges. The system offers a number of tutors and a variety of schedules 24 hours a day, 7 days a week on subject-specific areas to students. Students get unlimited use on a flat-fee, and can choose any subject matter that they are currently enrolled in at their local schools or subjects of interest. In this system, the tutors and students can be from all parts of the world in one class session.

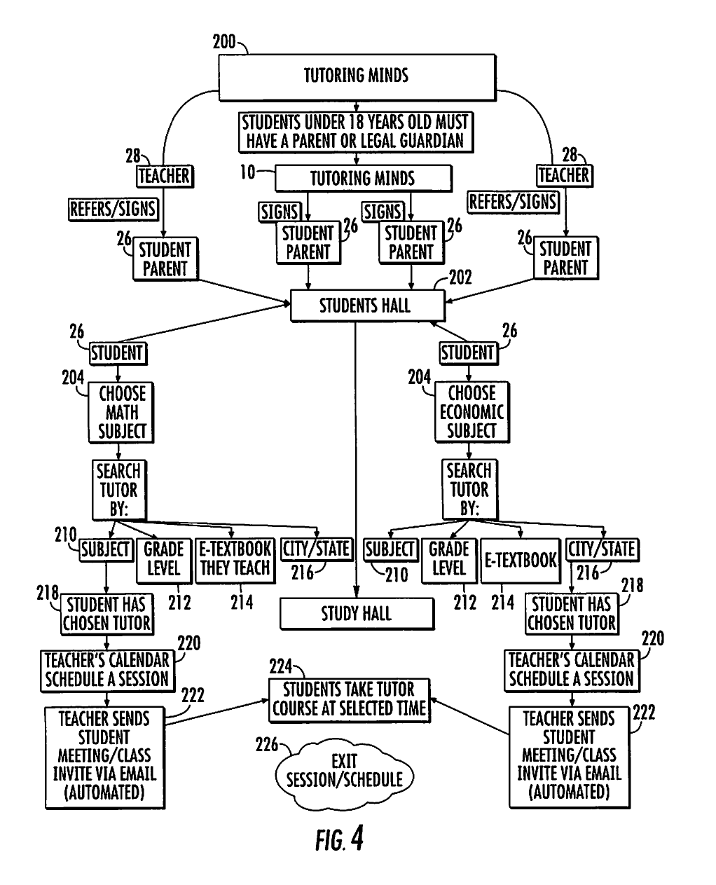

Each tutor can have up to 30 students in a class. Referring to FIG. 4, in order to subscribe to services of Tutoring Minds™ 200, students 26 must be either over 18 years of age, or must have a parent or a legal guardian to sign them with the system. The sign up process has been described in detail in embodiments of the present disclosure as depicted in FIGS. 1 and 3. A teacher 28 may recruit or refer any student 26 to the system 10. Once the student 26 signs up, he is directed to a “Students Hall” 202 (or the landing page 146 as depicted in FIG. 3). Once in the Students Hall 202, the student 26 may choose any specific subject matter 204 that is being offered. In one embodiment, specific subject matter 204 includes, but is not limited to, subcategories of each broader subject. Non-limiting examples of specific subject matter include fractions for math or cell division for biology.

In one embodiment, each tutor 28 teaches only a specific area of a subject or chapter rather than the whole subject or book and thus every student 26 in the classroom will only hear about the specific and restricted subject matter. For example, all the students in a particular class will be tutored on multiplication problems rather than addition. Also, each student in a class session is optionally taught from the same E-Textbook or worksheet that they are currently using in the schools.

Once the student 26 chooses a specific subject matter 204, he can search for a tutor based on the following non-limiting criteria: subject matter 210, grade level 212, e-textbook 214, or city/state 216. Non-limiting examples of subject matter 210 include biology, physics, sewing, economics, etc. Grade level 212 is a grade level which the student 26 is interested in learning, and does not necessarily correspond with the students' current grade level. E-textbook 214 refers to electronic textbooks that are provided by the system 10, which may correspond to the book that the student 26 uses at school. Search by city/state 216 allows the student 26 to limit his search to the geographical location of their interest. Once the student 26 has chosen a tutor 218, the student 26 accesses the tutor's calendar to schedule a session 220. Tutor 218 subsequently sends out notification 222 via email regarding the class meeting. In one embodiment, such notification 222 is automated once the name and email of all participants is identified. Students 26 take the tutor's course at the selected time 224 and exit 226 when the session is complete.

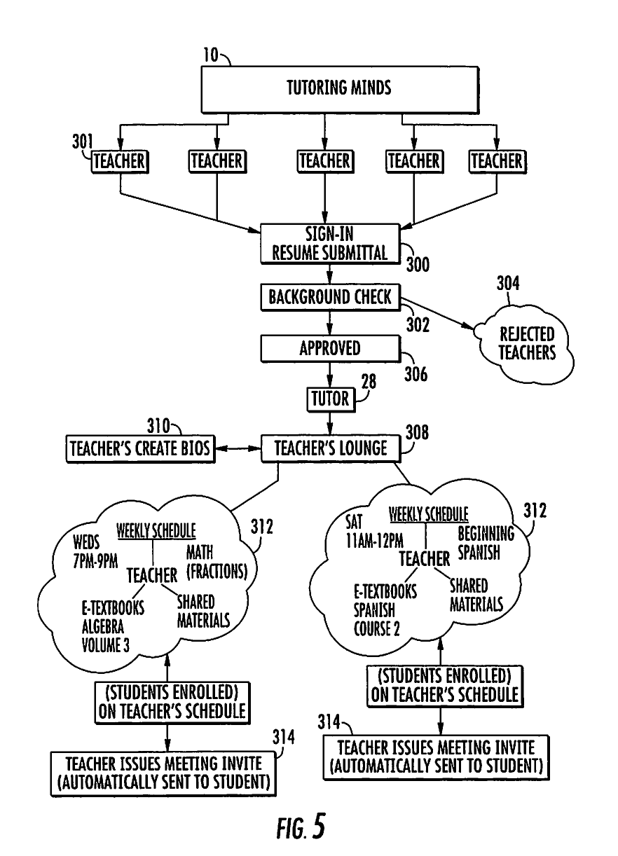

Referring to FIG. 5, in order to enter into the Tutoring Minds system 10 as a tutor 28, the tutor applicant 301 must sign in 300 by submitting basic biographical information, social security number and teaching certifications. The signing up process has been described in detail in embodiments of the present disclosure as depicted in FIGS. 1 and 2. Referring back to FIG. 5, once a background check 302 is performed, the tutor applicant 301 may be rejected 304 and barred from teaching in the system. Alternatively, if the tutor applicant 301 is approved 306, the tutor then is granted access to the Teacher's Lounge 308 (or the landing page 46 as depicted in FIG. 2). In the Teacher's Lounge 308, the tutor 28 creates his bio 310 which will be accessible to other students 26 and other tutors 28. In one embodiment, from the Teacher's Lounge 308, the tutor 28 selects a course or time he will be tutoring based on a schedule 312. Once tutor's 28 schedule 312 is set, a tutor receives information about the students who are enrolled on his schedule 312 and an automatic invitation 314 is sent to such students.

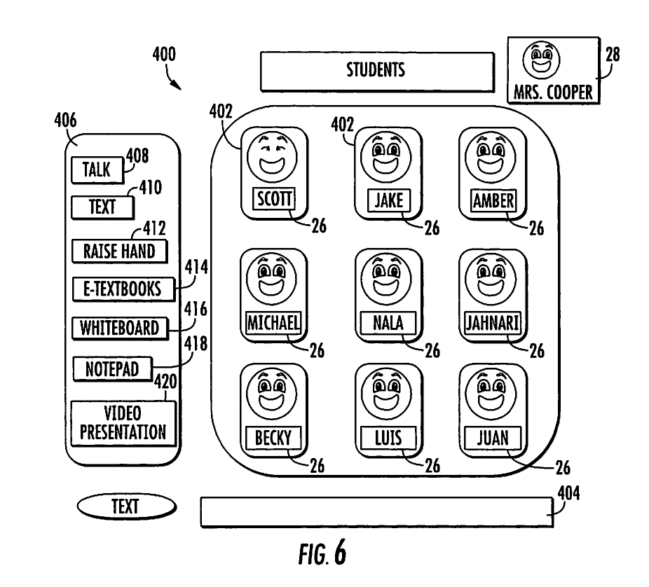

Referring to FIG. 6, a multi-video virtual classroom 400 is depicted. In one embodiment, one tutor 28 and at least one student 26, both with access to a video conferencing device 402 are present in the virtual classroom 400. The video conferencing device 402 is an electronic device that is connected to, or is part of the user's (i.e., tutor 28 and student 26) computer system that allows other user's in the system to see the individual in live, streaming format. Therefore, as illustrated in FIG. 6, if a student named Scott is participating in the virtual classroom 400, through Scott's video conferencing device 402, Mrs. Cooper (the tutor 28) and the other students in the class, such as Jake and Amber, can see Scott live. Therefore, both the tutor 28 and at least one student 26 are participating in the virtual classroom 400 via a video conferencing device 402.

Class participants (students 26 and tutor 28) can type messages to each other on a text bar 404 on their screen. Typing messages on the text bar 404 allows all participants to view the typed message. In yet another embodiment, every participant (students 26 and tutor 28) in the virtual classroom 400 has access to a communication tool bar 406 on his screen. The communication tool bar 406 includes, but is not limited to a talk button 408, which when pressed allows students to talk with other participants. The communication tool bar 406 further includes a text button 410 which when pressed redirects the participant to the text bar 404. The communication tool bar 406 further includes a raise hand button 412 to allow students 26 to raise their hand in case they have a question; an E-text book button to allow participants access an electronic format of a textbook that is dedicated for the class 400; a white board button 416 which directs the students 26 to a virtual whiteboard where they can freely write or erase any text during problem solving practices; a notepad button 418 which directs the students 26 to a screen where they can write notes relating to the class 400 for future review; and a video presentation button 420 where students 26 can review a recorded presentation of the class 400 at after it is finished.

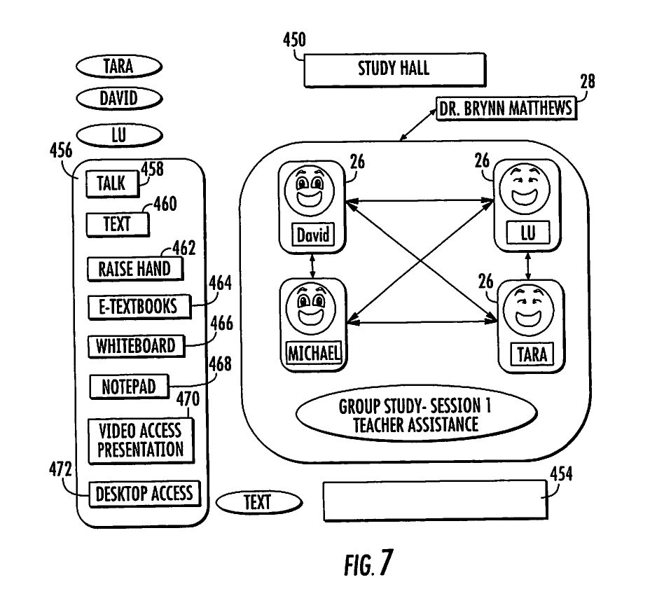

In one embodiment, each student 26 can have a one-on-one or group study session with other students on a section of a network-based web interference namely Study Hall 450, as depicted in FIG. 7. Study Hall 450 gives each student an opportunity to study with their classmates to figure out homework challenges or group projects such as current events, speeches, small or big essay reports, science projects, or any project imaginable without leaving their homes. In the Study Hall 450, students can also request the assistance of a tutor 28 knowledgeable in the subject pertaining to their respective individual or group projects.

For groups that request a tutor's assistance in the study hall 450, students must choose an open time slot that the tutor 28 has available on their calendar. The student (host) that initiates the meeting will insert number of students attending on the tutor's calendar. In one embodiment, every student has their own separate calendar for study hall reminders and such reminders are sent to students' email addresses.

In one embodiment, all tutoring sessions are recorded and monitored. There will be no time limit on any study hall sessions but if it idles for more than 30 minutes, the session will automatically end and must be rescheduled.

Referring back to FIG. 7, Study Hall 450 participants (students 26 and tutor 28) can type messages to each other on a text bar 454 on their screen. Typing messages on the text bar 454 allows all participants to view the typed message. In yet another embodiment, every participant (students 26 and tutor 28) in the Study Hall 450 has access to a communication tool bar 456 on his screen. The communication tool bar 456 includes, but is not limited to a talk button 458, which when pressed allows students to talk with other participants. The communication tool bar 456 further includes a text button 460 which when pressed redirects the participant to the text bar 454. The communication tool bar 456 further includes a raise hand button 462 to allow students 26 to raise their hand virtually in case they have a question; an E-text book button 464 to allow participants access an electronic format of a textbook that is dedicated for the Study Hall 450; a white board button 466 which directs the students 26 to a virtual whiteboard where they can freely write or erase any text during problem solving practices; a notepad button 468 which directs the students 26 to a screen where they can write notes relating to the Study Hall 450 for future review; a video presentation button 470 where students 26 can review a recorded presentation of the Study Hall 450 at after it is finished; and a desktop access button 472 that when pressed allows the student 26 to access the desktop on their computer.

In yet another embodiment, a method of recruiting tutors is described. This method involves recruitment of as many teachers to the network as possible. Tutors from a variety of backgrounds, education and geographical locations are recruited. Furthermore, teachers from local schools are utilized to recruit their current students and their peers into the network. Tutors will be paid for each additional teacher and student that is recruited and signed into the network. In one embodiment, tutors receive a monthly payment for any student he gets to join. In a shared teacher's network, teachers share duties which require up to 11 hours per week from the teachers. In this system, the teachers do not get paid on how many hours they work but on the number of students they get to join the network. If students join the network without a teacher referral, the students will be distributed evenly to teachers. This means that teachers can potentially get paid on students they don't recruit. Therefore, teacher's income is not set and they are paid in multi-levels.

In the shared network system, teachers recruit other teachers and other students from their schools to join. Once the student is in the network, he can use the teacher that recruited them as a tutor for one subject and use another teacher for a different subject. A paying student can choose a tutor from another state, if he chooses. The mission for this method and system is to help students from all backgrounds to have the same opportunity of overcoming homework challenges. The mission is also to significantly help turn around all graded “D” and “F” schools where they now become “A” and “B”.

Most people will agree that successful students have great study habits. Most will agree that the academic success of the student is created at home and if a child is failing, he is not receiving the help they need. Embodiments of the present invention provide the student with options for help needed with homework. These students don't have to get frustrated and give up at home because the homework is too hard. The student can now receive help on homework anytime they choose and they don't have to wait for their parents to be at home. All other methods are only able to help with 3 to 4 subjects, such as, but not limited to, math, English, biology. The shared-network tutoring method allows help with as many subjects as are present in the schools.

In the interactive online educational system, students do not have to be home to be tutored. If a student is sick at a hospital or away from home, they can log on to any personal computer and finish homework they missed with the teacher that issued it or another teacher on the network. Similarly, on the share network, teachers can teach from anywhere using IPADS or other personal computers.

The Multi-Level pay system, shared teacher network, teacher recruiting teacher, teacher recruiting student, and limited class size allows this system to have thousands of teachers in its network. Furthermore, the system allows for the ability to track and pay such tutors well while requiring low work hours per week.

In one embodiment, a low, flat price is charged for all family members. Therefore, multiple students can access the system. This includes the parents since most can benefit from career and professional tutorial services. The names of all family members must be listed at the time of sign up. To add additional family members at a later date, if the student is under 18 years of age, a copy of a school paper listing the current address is needed. Students have unlimited access to a variety of teachers/subjects which is cost effective and convenient for tutorial help. It simply gives the parents more options in seeking help for their child's homework challenges and academic goals. Furthermore, subsidized payments or free services are available to under privileged students.

Students all have different comprehension levels. Millions of students everyday leave the classroom not understanding their homework assignments. When a teacher asks, “Are there any questions or does everybody understand”, there are millions of students everyday that are scared to raise their hands. Furthermore, in most instances, the teachers are on a set schedule so they don't have time to slow down the class for one or two students. Because of these reasons, the students go home never fully understanding what they learned that day. Most parents, particularly those with underprivileged students, either don't have the time or are not knowledge enough in the subject to help their children with their homework. For the underprivileged, this homework may not get done. These students fall further and further behind which may lead to speculation of the students' lack of comprehension and/or the teacher's style of teaching. This lack of comprehension affects the students' homework, grades, and leads to failing test scores. Test scores have been the focus of the education in this country for so many years. For some students, with excellent comprehension skills this works; for those who struggle to understand their homework or class work, it's a failing situation.

Embodiments of the present invention are directed to a Cloud Web-based interactive System to help provide students with tutoring, instructional learning, digital literacy and any challenges with homework. One of the key components of this system is the “Global Shared Tutors Network” which further includes the tutor's overall compensation system and method.

The Global Shared Tutors Network is comprised of a variety of tutors worldwide with similar or different subject expertise. Tutors are not limited to teachers from schools, colleges, universities, professors, businesses, business employees and consulting and can merely be an expert in a specified subject.

If a tutor refers (“referee tutor”) a student (“referred student”) to join the network, the referred student can receive tutoring from the referee tutor, or alternatively the referred student can receive tutoring from any other tutor in the network on any subject at any time.

Although a teacher or tutor refers a student into the network, this doesn't mean that the referee tutor will be tutoring the referred student. The referee tutor may not tutor the referred student at all. The process behind the shared teacher's network is to have as many teachers with different subject matter expertise, for every subject in the network. In this system, teachers refer other teachers from their schools. Once the student is in the network, he can use the teacher that referred them as a tutor for one subject and use another tutor for a different subject. A student can choose a tutor from another state or country, if he chooses.

This computer network base business method and the shared tutor network eliminates the traditional and old method of high prices, per hour per tutor, per subject. Most tutors only tutor one subject, and most tutors only earn income by an hourly rate. This business method offers parents and students (of all ages and educational backgrounds) an inexpensive and affordable solution, which allows self pace tutoring, business education, business review, homework help, or homework review for all subjects. For the price of one or two traditional-method tutoring sessions per hour, per subject, per tutor, this method allows tutoring for every subject, anytime, for one low monthly price. All students have access to webcam, Audio, and Chat capability including language translations.

All tutoring, instructional learning, lessons, and homework help will be in the Homework Help Network and on a Virtual Campus. The Private Shared Tutors Network is created when a student searches the Global Shared Tutors Network and adds tutors he has chosen to interactively communicate with for homework help, homework review, tutoring, instructional learning, lessons and digital literacy purposes. This PSTN network will automatically be linked to tutors network.

The Private Shared Students Network is created when a student searches the Global Shared Students Network and add friends, study buddies, family members, classmates, for interactive communication, homework study, and tutoring purposes. The Private Shared tutors network for tutors is created when tutors search the Global Shared Tutors Network and add tutors for communications, shared materials, or as friends.

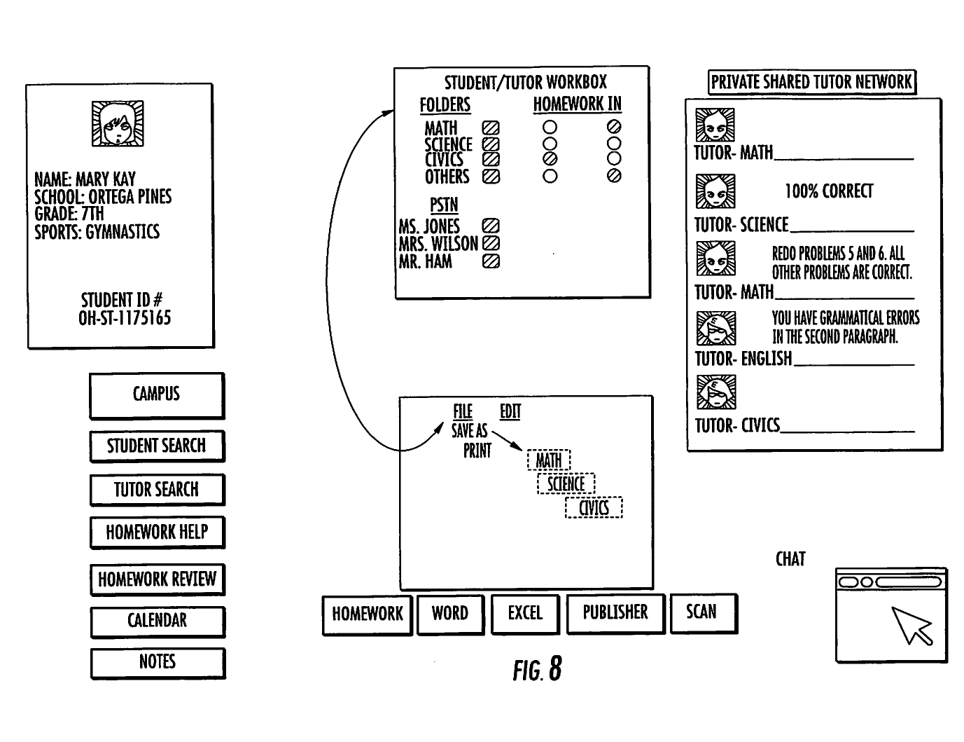

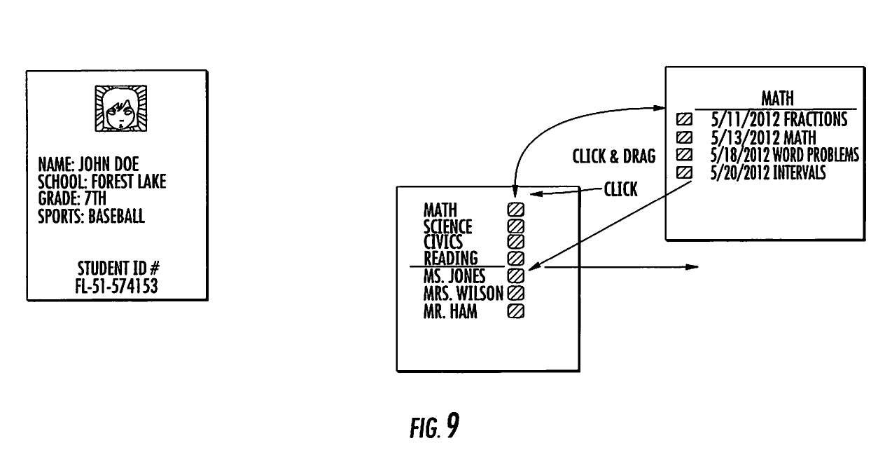

Referring to FIGS. 8 and 9, Homework Review Network is tied to the Global Shared Tutors Network or Private Shared Tutors Network for homework review purposes or review purposes of any digital document. In this network, students have access to all of the tutors for homework or project review. After a student finishes his homework or project such as an essay paper, research paper, or any homework assignment given by the classroom, the student can drop the assignment into any teacher's box for that particular subject, and request that the tutor review, pre-grade, and return it in less than 24 hours depending on the assignment. This way the student feels comfortable turning in homework, knowing it has been reviewed, by a certified teacher, without leaving their home.

Such review is for the purpose of, but not limited to, any digital document corrections or homework corrections before returning it back to school, college, or business. All reviews are scanned and saved to the student's personal homework archive folders. Any finished homework or digital document can be dragged and dropped to any tutor in the student's Private Shared Tutors Network. After pre-grade or corrections by the tutor, homework or digital documents will be dragged and dropped back to the student's workbox. All students will have chat capability including Language Translations.

Homework Archive is a computer based method, wherein students can save all homework or digital documents to their personal Homework Archive Folders for later use. Homework will be saved in the network for at least three months after student's last known contract. If contract renews, student resumes same Identification code.

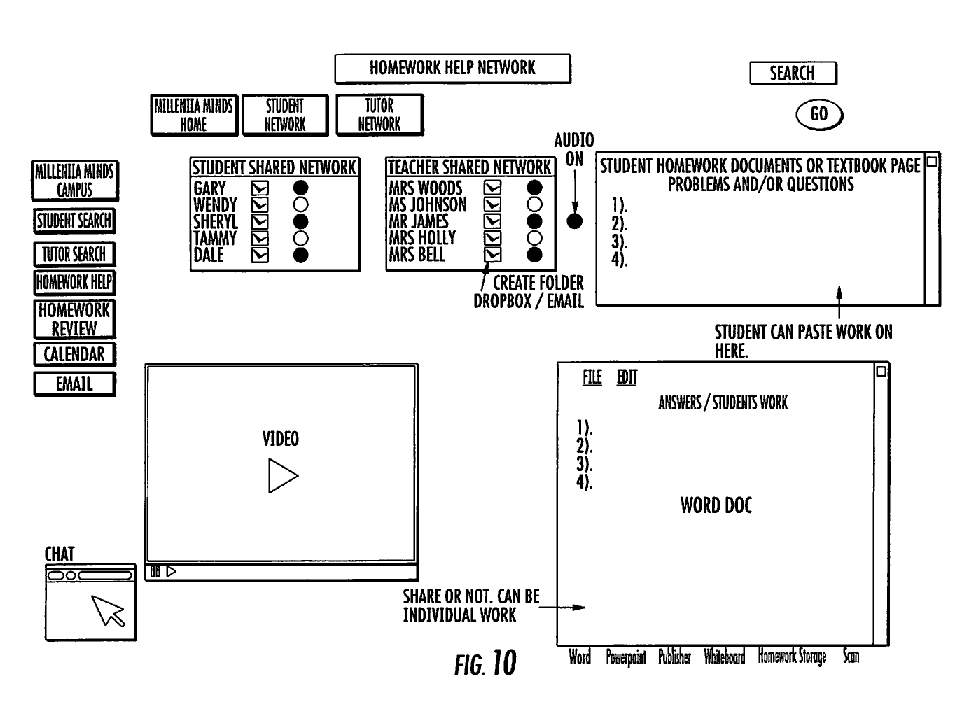

Referring to FIG. 10, Homework Help Network is a computer based network that is tied to the Private Shared Tutors Network and Private Shared Students Network for live instructional learning or homework help purposes. Homework Help Network is for students of all ages who frequently forget how to accomplish their homework assignments or simply didn't understand it. Many students leave school without having a clear understanding on how to accomplish their homework. In the classroom, teachers just don't have the time to repeatedly go over individual concerns, because each student comprehends differently. This affects student's grades severely, which then affects their test scores. Students can request a teacher at anytime to help them understand classroom assignments.

In this computer based network, there will be at least two windows viewable for showing at the same time for help with homework or finishing homework. Such windows include, but are not limited to, scanned saved homework, business work, whiteboard, word documents, excel documents, reading, video, reports and digital literacy of any kind.

Students can request homework help, instructional learning or digital literacy help and time from any tutor in their Private Shared Tutors Network. The student can choose to take the sessions by themselves or add friends or classmates to the homework help network. Any student or tutor requested in this homework-help session sees all the screens at the same time. Homework or Digital literacy can be scanned or uploaded to windows. All sessions will have webcam and audio capability. All finished homework can be saved to a personalized homework archive for later use. The finished homework can also be printed out, scanned and dropped to tutor's workbox. All Students will have chat capability including language translations.

In a Substitution/Vacation Network there will be a Calendar for every subject in this network. Every Calendar will have a list of all tutors who are requesting a substitute and the time substitution is needed. Each tutor will have a substitution calendar that links with calendar in Substitution Network. If the tutor finds substitute, he must send the substitute tutor the list of students in the class and the password associated with entering the classroom. Tutors can also use emails to request for a substitute. The tutor can go on vacation anytime or at own leisure, but must notify the system one week in advance. If classes or sessions are scheduled, then tutor must find substitute.

Every tutor's schedule or personal calendar will be viewable within the Shared Network. When scheduling in the virtual Campus, tutors will have a personal campus password to access the campus buildings. This access will be used for scheduling tutoring sessions on the Campus Calendar for a particular room or rooms. After the tutor applies the schedule that best fits them for that particular week or month, the schedule will automatically be linked to the Campus' Calendar, tutor's personal calendar, and the student's Private Shared Tutors Network to whom he is added to. When a Student selects a tutor for a classroom session, the student's inquiry will automatically be linked to the Tutor's Schedule or Classroom schedule for that particular time. Tutors will be notified in real time

Tutors will have an up to date attendance list of all students that are scheduled for that particular class. An hour before class begins, a Classroom password will be sent out to each student who is on the tutor's attendance list for that particular date and time in that particular classroom. For the Homework Help Network, the student will have the option to request any tutor. Requested time will show up on Tutor's personal network email account, if the tutor accepts the time given by the Student, then the tutor will set schedule or Calendar for that particular date and time which will be linked to the student's calendar. The requesting student must first add tutor to his Private Shared Tutors Network.

For the Homework Review Network, tutors will set their particular review times in their personal Calendars to be viewable by all students.

Banking points is another form of compensation for the tutors. Tutors will receive banking points based on, but not limited to, the number students he tutors, popularity, the number of hits they receive from students, employment at the system, and the number of good reviews.

Banking points are also a student's incentive. Students can receive prizes or gifts, including scholarships based on academics, the number of banking points, and credit hours received through the system.

The system will comprise a virtual campus. In the virtual campus there will be buildings which are marked with the main subject name (i.e., Math). Once a building is selected, there will be multiple classrooms with the room numbers, the Grade levels and specific subject in which the student want tutoring.

Before coming to this section or to access the classrooms, the student's tutor will send the student a room number, time, and password in which to enter. All classrooms will be recorded. Once a student is in the class, he has access to E-textbooks, can see the tutor, has access to the desk top, whiteboard, and other communication tools to complete the class. Once the class is over, the student will exit or logout of the classroom and schedule the next session. The student can also choose the study hall building which allows him to study with friends. The system further houses educational videos in the Virtual Campus Library. If a student request a class, but never makes it, no credit will be issued.

Embodiments of the present invention are directed to an effective Tutoring Model where tutors worldwide share a computer-based tutoring platform, homework help platform, homework review platform, instructional learning platform, classroom platform or/and communication tools with other tutors in the network to accomplish student educational challenges while sharing revenue which stems from a per household or individual pricing model.

Embodiments of the present invention are directed to an effective Tutoring Model where tutors worldwide share a computer-based tutoring platform, homework help platform, homework review platform, instructional learning platform, responsibilities, classroom platform or/and communication tools with other tutors allowing parents, students an affordable solution to homework help, tutoring, instructional learning or any digital learning with a per household pricing model.

Embodiments of the present invention are directed to a homework help network where students uploads or scans homework to database to be shown on computer screens or windows for interactive communications between tutor or/and student for homework help or to accomplish homework challenges.

In general, the foregoing description is provided for exemplary and illustrative purposes; the present invention is not necessarily limited thereto. Rather, those skilled in the art will appreciate that additional modifications, as well as adaptations for particular circumstances, will fall within the scope of the invention as herein shown and described and the claims appended hereto.

What is claimed is:

1. An online interactive educational system, the system comprising:
a network;
first and second computers connected to and providing access to the network for a student and a tutor, respectively;
a database server connected to the network for storing data pertaining to the student and the tutor;
system software connected to the first and second computers and to the database server for coordinating interaction between the tutor and the student;
each computer having a two-way video interface wherein each student can interact live with the tutor or another student; and
a plurality of communication tools connected in the network to facilitate discussions between each student and the tutor.

2. The system of claim 1, wherein the communication tools includes talk, text, and chat.

3. The system of claim 1, further comprising an online homework network wherein the student uploads homework to the database server.

4. The system of claim 3, wherein the database server permits the tutor to review the student's homework assignment without online instant discussion between the tutor and the student.

5. The system of claim 3, wherein the video interfaces permit the tutor to review at least one student's homework assignment through an online instant discussion between the tutor and the student.

6. An online interactive educational method, the method being executed by at least two network-connected computers, the method comprising:
providing a network;
associating first and second computers with the network and with a student's and a tutor's database, respectively;
storing at least one tutoring event for a specific subject by the tutor in a central database server;
providing access with software to the tutoring event for at least one student and one tutor;
providing a multi-video, web-based interface wherein the student interacts live with the tutor or another student through the software; and
providing a plurality of communication tools to facilitate instant discussions between each student and the tutor, wherein the tutor and at least one student interact with each other.

7. The method of claim 6, further comprising providing a homework network wherein the student uploads a homework assignment onto the database server and the tutor reviews the homework on the database server.

8. The method of claim 7, wherein the tutor reviews the student's homework assignment without online instant discussion between the tutor and the student.

9. The method of claim 7, wherein the tutor reviews at least one student's homework assignment through the online instant discussion between the tutor and the student.

10. The method of claim 6, further comprising the additional step of providing a calendar of all tutoring events associated with each tutor to every student.

11. A method of calculating a tutor's overall compensation in an online interactive educational system, the method comprising:
(a) associating a first compensation value with every referred student to the system by the tutor;
(b) associating a second compensation value with every student who has an educational interaction with the tutor, wherein the educational interaction comprises at least one of online interactive tutoring, online interactive homework help and offline interactive homework help;
(c) multiplying the first compensation value by a number of the referred students to determine the first reimbursement value; and
(d) multiplying the second compensation value by number of the students with the educational interaction to determine the second reimbursement value, wherein the tutor's overall compensation is calculated by adding the first and second reimbursement values.

12. The method of claim 11, wherein the first compensation value is less than the second compensation value.

13. The method of claim 11, wherein the referred student by the tutor can utilize the educational interaction of another non-referred tutor in the system.

14. The method of claim 13, wherein the non-referred tutor will not be compensated for the first compensation value of the student.

15. The method of claim 11, wherein the tutor is further compensated based on a number of banking points the tutor receives from each student, wherein the banking points includes popularity of the tutor with students, good reviews from students and duration of work in the system.

16. The system of claim 1, wherein the specific learning subject comprises career-related tutoring, academic tutoring and non-academic tutoring.

17. The system of claim 1, wherein the multi-video, web-based interface allows the student and the tutor to view each other on the system through use of video device connected to the student's and the tutor's computer.

18. The system of claim 1, further comprising a shared tutor's platform, wherein plurality of tutors share revenue and educational tasks associated with the student.

19. The system of claim 18, wherein the shared platform provides an affordable solution for educational needs of the student.
